(19) United States
(12) Patent Application Publication
(10) Pub. No.: US 2009/0130893 A1
(43) Pub. Date: May 21, 2009

(54) Clamping Device for a Connection Terminal

(75) Inventors: Noel Revollon, Decines Charpieu (FR); Philippe France, Chazelles Sur Lyon (FR)

Correspondence Address: OLIFF & BERRIDGE, PLC, P.O. BOX 320850, ALEXANDRIA, VA, 22320-4850, US

(73) Assignee: ABB France, Rueil-Malmaison (FR)

(21) Appl. No.: 11/887,140

(22) PCT Filed: Mar. 23, 2006
(86) PCT No.: PCT/FR2006/000646

§ 371 Date: Nov. 28, 2007

(30) Foreign Application Priority Data
Apr. 6, 2005 (FR) 05 03424

(51) Int. Cl. H01R 13/58

(52) U.S. Cl. 439/460

(57) ABSTRACT

A connection terminal clamping device clamping a conductor wire to a connection conductor bar comprises a part forming a conductor housing provided with at least one upwardly oriented opening for receiving at least one connectable conductor wire and the connection conductor bar, a clamping spring which maintains the conductor wire introduced into a housing-forming part in position against the conductor bar by means of an elastic force and which comprises a first connecting arm formed by the extension of a wall defining said housing-forming part and connected by an elbow to a second clamping arm provided with a free clamping end.

The present invention relates to a conductor clamping device designed to be fitted to a low voltage apparatus clamping terminal.

In order to achieve the electric contact between the end of an electric conductor and a conductor element of a low voltage apparatus, and in particular with a connection bar of a terminal block, it is a known practice to use clamping connection terminals.

It is in particular advantageous to produce clamping terminals into which a conductor may be inserted for the purpose of a connection, without the need to use a tool to move aside a clamping spring.

To remove the conductor from the clamping terminal, a tool is usually used to move aside the clamping spring.

The stiffness of the elastic clamping spring must be suitable to make it possible both to hold the conductor in contact with the connection bar and to insert the conductor against the elastic force.

It is a known practice to use a clamping terminal comprising a device in which the bar is attached or held in position by clamping, the device comprising several different component elements, particularly component elements of a housing cage of the conductor and a spring.

This multiplicity of elements complicates the mounting of such a terminal and its manufacture.

Additionally, the width of the elastic member is constrained by the dimensions of the cage. Consequently, to obtain the desired stiffness of the spring in an acceptable space, it is necessary to use different materials for the elastic member and for the cage.

If the choice is made to produce the whole device in a single piece, the spring cannot have the desired stiffness.

The object of the present invention is to provide a clamping device for a clamping terminal whose mounting and manufacture are simplified, while making it possible to obtain the sought-after stiffness features.

Accordingly, the subject of the present invention is a clamping device for a terminal for connection by clamping a conductor wire to a conductor connection bar, comprising:
a portion forming a conductor housing, comprising at least one upward opening designed to receive at least one conductor wire to be connected, and the conductor connection bar,
a clamping spring designed to hold in position the conductor wire inserted into the portion forming a housing against the connection bar by applying an elastic force, the clamping spring comprising a first, connection branch formed by an extension of a portion of a wall delimiting the portion forming a housing, connected via an elbow to a second, clamping branch having a free clamping end,
   wherein the elbow between the first, connection branch and the second, clamping branch is situated at least partly on the side opposite to the housing opening, relative to the plane of the wall portion delimiting the portion forming a housing of which the first, connection branch forms the extension,
   and in that the opening designed to receive at least one conductor wire is situated on the opposite side of the wall portion delimiting the portion forming a housing, relative to the clamping branch.

These arrangements make it possible to achieve a simple manufacture and mounting. Furthermore, the spring extending partly outside the housing portion is not constrained by the dimensions of the latter. The arrangement behind the opening makes it possible to obtain a better stiffness of the spring.

According to one embodiment, the housing portion comprises a housing cage comprising a side wall having at least one upward opening.

Advantageously, the housing portion comprises a bearing portion situated in the extension of a second wall portion of the cage opposite to the first wall portion whose extension forms the clamping spring.

According to one embodiment, an opening is arranged in the bearing portion.

Advantageously, the free end of the clamping branch of the clamping spring is situated in the opening in the rest position of the spring.

According to one embodiment, the clamping spring comprises at least one portion having a width greater than that of the cage.

Advantageously, the spring comprises at least two portions of different width.

According to one embodiment, the device is formed in a single piece, by bending.

Advantageously, the device is made of a cut material comprising a first strip designed to form the housing portion and a second portion substantially transverse to the first designed to form the spring by curving and bending.

According to one embodiment, a cage is formed by bending a strip of material having two portions of matching shapes designed to be housed in one another.

The subject of the present invention is also a low voltage apparatus comprising a clamping device as described above.

In any case, the invention will be well understood with the aid of the following description, with reference to the appended schematic drawing representing, as a nonlimiting example, an embodiment of a device according to the invention.

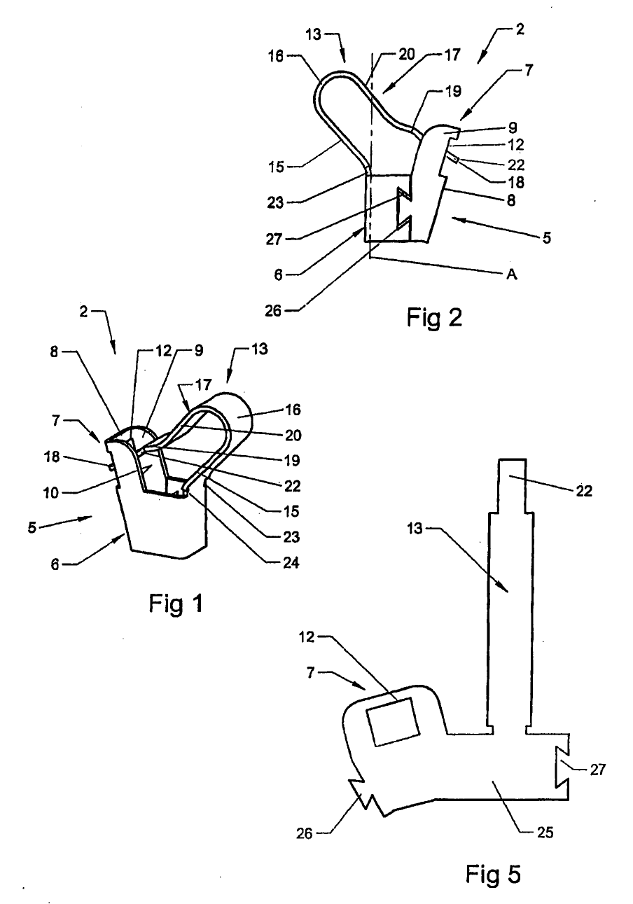

FIG. 1 is a view in perspective of a clamping device according to one embodiment.

FIG. 2 is a front view of the element of FIG. 1.

FIG. 3 is a view in section of the element of FIG. 1, a connection bar being inserted into the housing portion.

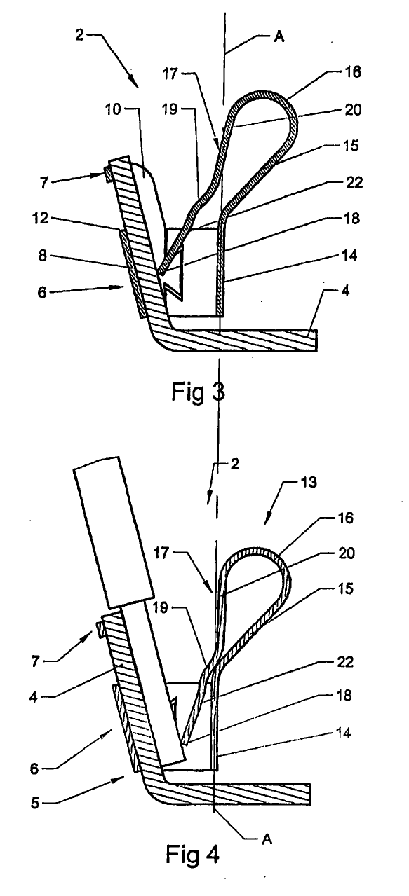

FIG. 4 is a view in section of the element of FIG. 1, a connection bar being inserted into the housing portion, a conductor being connected.

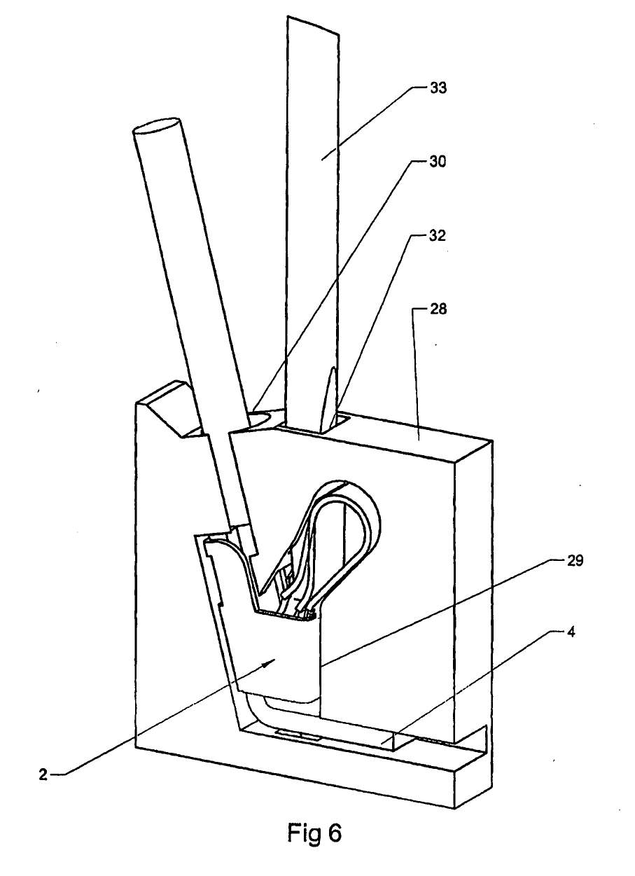

FIG. 5 is a front view of the profile of a cut plate designed to form the device of FIG. 1 after bending.

FIG. 6 is a view in perspective of the device of FIG. 1 and of a portion of a low voltage apparatus designed to receive it.

According to one embodiment shown in FIGS. 1 to 6, a clamping device 2 for a terminal for connection by clamping a conductor wire 3 to a conductor connection bar 4 comprises a portion forming a housing 5 designed to receive the conductor 3 to be connected comprising:
a cage 6 comprising a side wall of substantially rectangular section opening upward,
a bearing portion 7 extending beyond the cage in the extension of the latter.

The bearing portion comprises:
a first face in the extension of a first flat bearing face 8 of the cage 6, and
two side walls forming a partial extension of two lateral faces 9, 10 adjacent to the first flat face 8.

The portion forming a housing 5 is designed also to receive the connection bar 4, that is placed against the first flat bearing face 8 of the cage 6 of the housing portion 5.

An opening 12 is arranged in the bearing face 8 at the bearing portion 7.

The device also comprises a clamping spring 13 designed to hold in position against its elastic force a conductor 3 inserted into the housing portion 5.

The clamping spring 13 consists of an extension of a second flat face 14 of the wall of the housing portion 5, situated at the end opposite to the first flat face 8.

This clamping spring 13 comprises:
a first, connection branch 15 connected via a first end to the second face 14 of the housing portion 5, forming the extension of the latter,
an elbow 16 connected to the second end of the first, connection branch 15, and
a second, clamping branch 17, connected to the elbow 16 via its first end and having a second free clamping end 18.

The elbow 16 between the first, connection branch and the second, clamping branch is situated on the side opposite to the opening of the housing, relative to the plane A of the second flat face 14.

The upward opening of the portion forming a housing 5, designed to receive at least one conductor wire, is situated on the opposite side of the second face 14, relative to the clamping branch 17.

The clamping end 18 is designed to hold in position a conductor 3 inserted into the housing portion 5 against the connection bar 4.

This arrangement makes it possible to increase the prestress of the spring relative to the position occupied when the bar is in position in the housing, the inclination of the clamping branch of the spring relative to the bar serving as a bearing surface being increased.

Therefore, the stiffness of the spring is increased.

The clamping end 18 of the spring is situated, in the rest position of the spring, in the opening 12 of the bearing portion 7.

This arrangement also makes it possible to increase the stiffness of the spring.

It should be pointed out also that the clamping spring comprises a boss 19 directed outward from the spring 13, and making it possible to form an abutment for the screwdriver or other tool designed to push away the spring for the purpose of removing the conductor 3 connected thanks to the device 2.

The clamping branch 17 of the spring comprises two portions 20 and 22 separated by the boss 19, the second portion 22 situated close to the end 18 having on its terminal portion a restricted width making it possible to house the clamping end 18 between the side faces 9, 10 of the bearing portion 7.

The arrangement according to which the spring is formed in the extension of a face of the housing portion, and thus according to which the spring, with the exception of the terminal portion, is situated outside the housing portion, makes it possible to produce a spring whose width is greater, because the latter is not limited by the width of the housing portion. It is therefore possible easily to obtain the desired stiffness for the spring without using a specific material.

Narrowings 23, 24 situated at the base of the connection branch, at the connection with the second flat face of the housing portion, make it possible to dispense with stresses of bending the material.

As shown in FIG. 5, the device 2 is made in a single piece from a plate-shaped material. The portion forming the cage is formed of a strip 25 comprising at each of its ends respectively a trapezium-shaped lug 26 and a housing 27 of matching shape, in order to be able to form, by bending, a shape-matching fastening.

Also visible are the portions designed to form the bearing portion 7 and the clamping spring 9, forming side extensions of the strip 25.

FIG. 6 represents a portion of the insulating body of a low voltage apparatus 28 comprising a housing 29 designed to receive a device 2 and a connection bar 4.

The body of the apparatus comprises a conductor insertion opening 30 and an opening 32 for inserting a tool 33, used for removing the conductor from the terminal thus formed.

It goes without saying that the invention is not limited to the preferred embodiment described above as a nonlimiting example; on the contrary, it covers all the variants in the context of the following claims.

1. A clamping device for a terminal for connection by clamping a conductor wire to a conductor connection bar, comprising:
a portion forming a conductor housing, comprising at least one upward opening designed to receive at least one conductor wire to be connected, and the conductor connection bar,
a clamping spring designed to hold in position the conductor wire inserted into the portion forming a housing against the connection bar by applying an elastic force, the clamping spring comprising a first, connection branch formed by an extension of a portion of a wall delimiting the portion forming a housing, connected via an elbow to a second, clamping branch having a free clamping end,
wherein the elbow between the first, connection branch and the second, clamping branch is situated at least partly on the side opposite to the housing opening, relative to the plane of the wall portion delimiting the portion forming a housing of which the first, connection branch forms the extension,
and in that the opening designed to receive at least one conductor wire is situated on the opposite side of the wall portion delimiting the portion forming a housing, relative to the clamping branch.

2. The device as claimed in claim 1, wherein the housing portion comprises a housing cage comprising a side wall having at least one upward opening.

3. The device as claimed in claim 2, wherein the housing portion comprises a bearing portion situated in the extension of a second wall portion of the cage opposite to the first wall portion whose extension forms the clamping spring.

4. The device as claimed in claim 3, wherein an opening is arranged in the bearing portion.

5. The device as claimed in claim 4, wherein the free end of the clamping branch of the clamping spring is situated in the opening in the rest position of the spring.

6. The device as claimed in claim 2, wherein the clamping spring comprises at least one portion having a width greater than that of the cage.

7. The device as claimed in claim 1, wherein the spring comprises at least two portions of different width.

8. The clamping device as claimed in claim 1, which is formed in a single piece, by bending.

9. The clamping device as claimed in claim 8, which is made of a cut material comprising a first strip designed to form the housing portion and a second portion substantially transverse to the first designed to form the spring by curving and bending.

10. The device as claimed in claim 9, wherein a cage is formed by bending a strip of material having two portions of matching shapes designed to be housed in one another.

11. Low voltage apparatus comprising a clamping device as claimed in claim 1.
